(19) United States
(12) Patent Application Publication
(10) Pub. No.: US 2012/0274783 A1
(43) Pub. Date: Nov. 1, 2012

(54) IMAGING WITH REAL-TIME TRACKING USING OPTICAL COHERENCE TOMOGRAPHY

(75) Inventors: Tony H. KO, Cupertino, CA (US); Xingzhi LUO, Sunnyvale, CA (US); Yonghua ZHAO, Pleasanton, CA (US); Ben JANG, Cupertino, CA (US)

(73) Assignee: OPTOVUE, INC., Fremont, CA (US)

(21) Appl. No.: 13/458,531

(22) Filed: Apr. 27, 2012

Related U.S. Application Data
(60) Provisional application No. 61/481,055, filed on Apr. 29, 2011.

(51) Int. Cl. H04N 5/225

(52) U.S. Cl. 348/169; 348/E05.024

(57) ABSTRACT

An optical coherence tomography system is provided. The system includes an OCT imager; a two-dimensional transverse scanner coupled to the OCT imager, the two-dimensional transverse scanner receiving light from the light source and coupling reflected light from a sample into the OCT imager; optics that couple light between the two-dimensional transverse scanner and the sample; a video camera coupled to the optics and acquiring images of the sample; and a computer coupled to receive images of the sample from the video camera, the computer processing the images and providing a motion offset signal based on the images to the two-dimensional transverse scanner.

### RELATED APPLICATIONS

This application claims priority to U.S. Provisional Application 61/481,055, filed on Apr. 29, 2011, which is herein incorporated by reference in its entirety.

### BACKGROUND

1. Field of the Invention

Embodiments of this invention relate to the field of medical imaging. Specifically, some embodiments pertain to apparatus and methods for improving the quality of optical coherence tomography (OCT) images with the use of real-time video tracking technology.

2. Description of Related Art

Optical coherence tomography (OCT) is a high-resolution imaging technology used for in vivo cross-sectional and three-dimensional imaging of biology tissue microstructure (Wolfgang Drexler and James G. Fujimoto, [Optical Coherence Tomography: Technology and Application, Springer (2008)]). OCT has been used extensively for non-invasive imaging of the human eye for the past two decades.

Fourier-domain OCT (FD-OCT) is gaining popularity and has become a mainstream technology for non-invasive microstructure imaging due to its improved imaging speed and sensitivity. (See for example, Wojtkowski M. et al., [J. Biomed. Opt. 7,457-463 (2002)], Leitgeb R. et al., [Opt. Express 11, 889-894 (2003)], Choma M. A., et al., [Opt. Express 11, 2183-2189 (2003)], or de Boer J. F. et al, [Opt. Lett. 28, 2067-2069 (2003)]). Current commercial Fourier-domain OCT systems have imaging speeds between 25,000 to 53,000 axial scans (A-scans) per second. These imaging speeds enable a typical cross-sectional OCT image (B-scan) to be acquired in a few hundredths of a second. Due to short duration of image acquisition time, transverse motion artifacts caused by micro-saccadic movement of an object eye are insignificant in most OCT B-scan images. Axial motion artifacts caused by heart beat, respiration, and head movement are also minimized in a typical FD-OCT cross-sectional image.

It has been shown that the image quality of an OCT image can be improved through the reduction of speckle noise in the image by averaging multiple B-scans acquired at the identical location. (See for example, Sander B. et al., [Br. J. Ophthalmol. 89, 207-212 (2005)], Sakamoto A. et al., [Ophthalmology 115, 1071-1078.e7 (2008)], or Hangai M. et al., [Opt. Express 17, 4221-4235 (2009)]). Despite the increase in imaging speed of FD-OCT, transverse and axial motion artifact can still be an issue when the number of B-scans used for averaging is increased such that the total acquisition time approaches a few tenth of a second. An OCT image obtained through multiple B-scans averaging is likely to have blurring effects due to the averaging of backscattered signals from different locations as a result of motion artifacts during acquisition. Since the acquisition of a complete three-dimensional data set of an object eye using FD-OCT typically requires several seconds, transverse and axial motion artifacts are likely to occur and affect image quality. Therefore, an apparatus and a method are needed to track the motion of an object eye in real-time in order to improve the quality of OCT imaging and to preserve accurate three-dimensional anatomical information.

In an attempt to solve this problem, some commercial OCT systems use a separate laser scanning imaging system (also known as a scanning laser ophthalmoscope or SLO) to perform real-time transverse tracking of the OCT scanning beam (Hangai M. et al., [Opt. Express 17, 4221-4235 (2009)]). This approach increases the complexity and, therefore, the cost of the system as a whole; it also exposes the subject to additional optical radiation from the SLO beam.

To reduce the system complexity, near-infrared video images of the fundus was also used in an attempt to perform transverse tracking of OCT imaging. Koozekanani disclosed a method to track the optic nerve head in OCT video using dual eigenspaces and an adaptive vascular distribution model. (Koozekanani D. et al, [IEEE Trans Med Imaging, 22, 1519-36 (2003)]). However, such complex modeling is computationally intensive and cumbersome; and such motion tracking was not feasible in real-time due to its complexity.

Therefore, there is a need for better apparatus and method of motion tracking of OCT image data.

### SUMMARY

In accordance with some embodiments, an optical coherence tomography (OCT) system is provided. An optical coherence tomography (OCT) system according to some embodiments includes an OCT imager; a two-dimensional transverse scanner coupled to the OCT imager, the two-dimensional transverse scanner receiving light from the light source and coupling reflected light from a sample into the OCT imager; optics that couple light between the two-dimensional transverse scanner and the sample; a video camera coupled to the optics and acquiring images of the sample; and a computer coupled to receive images of the sample from the video camera, the computer processing the images and providing a motion offset signal based on the images to the two-dimensional transverse scanner.

In some embodiments, an imaging method includes directing an OCT light source from an OCT imager onto a sample; capturing an OCT image in the OCT imager; capturing video image of the sample using a video camera; analyzing the video image to determine a motion correction; and adjusting positioning of the OCT light source on the sample in response to the motion offset.

These and other embodiments are further described below with respect to the following figures.

### BRIEF DESCRIPTION OF THE DRAWINGS

FIG. 1 shows a system diagram of an OCT system with a near-infrared camera.

FIG. 2 shows a flowchart of OCT data acquisition without motion detection and correction.

FIG. 3 illustrates the motion artifact in a standard 3D OCT image without tracking.

FIG. 4 shows an averaged B-scan acquired without tracking.

FIG. 5 is a system diagram in accordance with some embodiments of the present invention.

FIG. 6 is an exemplary flowchart for motion detection and tracking.

FIG. 7 is an exemplary flowchart of OCT data acquisition with motion detection and correction.

FIG. 8 shows an example of a tracked 3D OCT image without motion artifact.

FIG. 9 shows an exemplary averaged B-scan acquired with real-time tracking.

### DETAILED DESCRIPTION

The present invention provides solutions to address some of the drawbacks of these tracking approaches. Methods and apparatus for performing real-time transverse tracking using video images to achieve registration of the OCT scan positions are disclosed. A rapid and efficient algorithm can be used to obtain real-time tracking information using near-infrared video images. The real-time tracking detects transverse eye motion and actively moves the OCT scanning beam to the intended scan location. This active tracking system removes out-of-position OCT scans and facilitates the acquisition of OCT data from well-defined scan locations in the three-dimensional space. The optical backscattering intensity along each A-scan can be obtained through standard FD-OCT acquisition and processing. Sequential OCT B-scans can be aligned in the transverse, axial, and rotational directions to perform axial scan registration. OCT B-scans acquired from identical location and registered in this manner are suitable for improving the OCT image quality through multiple B-scan averaging. OCT B-scans acquired and processed in this manner can also be used to acquire three-dimensional data set with nearly no motion artifacts.

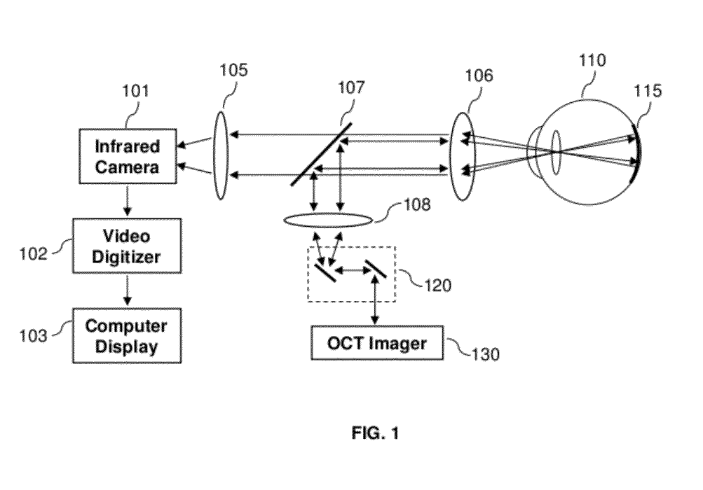

In some embodiments of the present invention, infrared video can be used to achieve real-time tracking and three-dimensional registration of OCT data acquisition. FIG. 1 shows a typical OCT system containing a standard OCT Imager 130, two-dimensional (2D) transverse scanners 120, a beam splitter 107 to provide simultaneous viewing of the sample 110 and the imaged region of interest 115. The OCT Imager 130 is typically a Fourier-domain OCT system in the field of ophthalmology, a time-domain OCT system can also be used. In addition, the Fourier-domain OCT system can be either based on a spectrometer or based on a rapidly tuned laser, also known as a “swept source”. In general, OCT Imager 130 includes an OCT light source and a detector that receives reflected light. In some embodiments, the simultaneous viewing of the scanning region can be provided by an infrared camera 101 where the video images are typically captured by a video digitizer 102 for display onto a computer display 103 to provide an operator continual feedback of OCT scanning position relative to the anatomical region of interest during image acquisition. Various optical lenses 105, 106 and 108 focus the OCT beam and the video image onto the region of interest 115 in the sample 110.

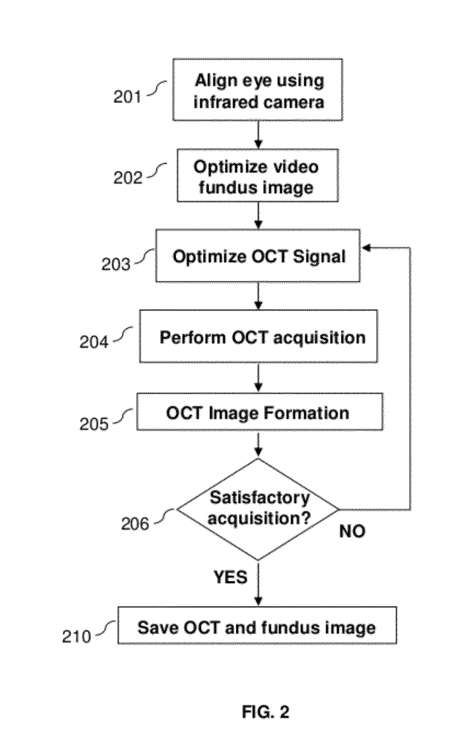

FIG. 2 illustrates a flowchart showing the steps of OCT data acquisition using the system as disclosed in FIG. 1 without motion detection and correction. As shown in the method of FIG. 2, the operator uses the infrared camera 101 to align the sample 110 such as a human eye as in step 201. As is commonly performed during OCT acquisition, once the sample 110 is sufficiently aligned in step 201, the operator then moves the OCT device closer to the sample 110 in order to focus the video image onto the region of interest 115, such as the fundus of a human eye as in step 202. After the video image showing the region of interest 115 is sufficiently optimized, the operator proceeds to optimize the OCT signal in step 203 in preparation for OCT data acquisition in step 204. OCT signal is then acquired and digitized into a computer where signal processing commonly used in the field is performed to generate OCT images, as in step 205. The operator can decide in step 206 whether the acquired OCT images are of sufficient quality. When the OCT images are not of sufficient quality (NO in step 206), the acquisition process returns to step 203 to re-optimize the OCT signal. On the other hand, when the OCT images are of sufficient quality, the next step is to save the OCT data and fundus image as in step 210.

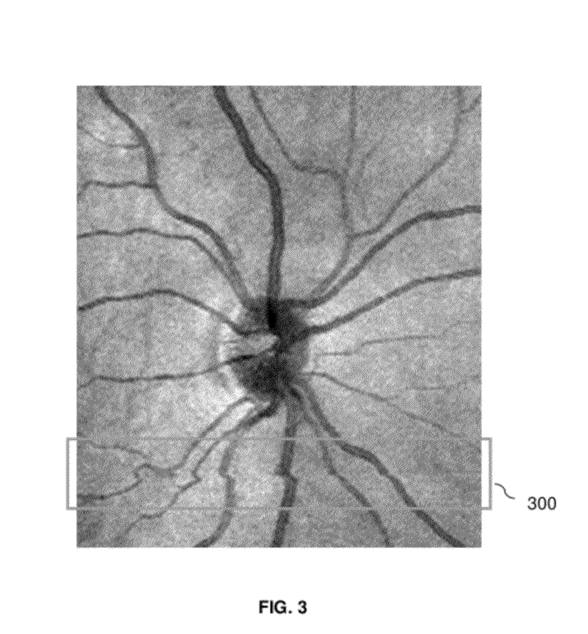

Commercially available Fourier-domain OCT systems have imaging speeds in the range of several tens of thousands of axial scans (A-scans) per second. At these speeds, an individual cross-sectional OCT image (B-scan) will likely not contain significant motion artifacts from involuntary micro-saccadic motion, or motion due to subject's breathing, heart beat or head movement. However, the acquisition of a complete three-dimensional data set at these imaging speeds still requires up to a few seconds. This results in motion artifacts as shown in FIG. 3. In FIG. 3, a three-dimensional OCT data set was acquired over a region of the human optic nerve head using the system in FIG. 1. The motion artifact in the inferior portion 300 of this 2D representation of the three-dimensional OCT data is clearly shown. In portion 300, the blood vessels are disrupted and do not conform to real anatomy of the eye. This motion artifact is likely caused by the involuntary micro-saccadic movement of the subject during the 3D OCT data acquisition.

One of the advantages of using motion detection and correction is to reduce the motion artifact shown in FIG. 3. Another advantage of motion detection and correction is to improve image quality of an OCT image by averaging multiple B-scans acquired at the same intended location. However, when the number of B-scans used for averaging is increased, the resultant OCT image obtained through averaging will have blurring artifacts as a result of the superimposition of signals not obtained in the same locations due to motion.

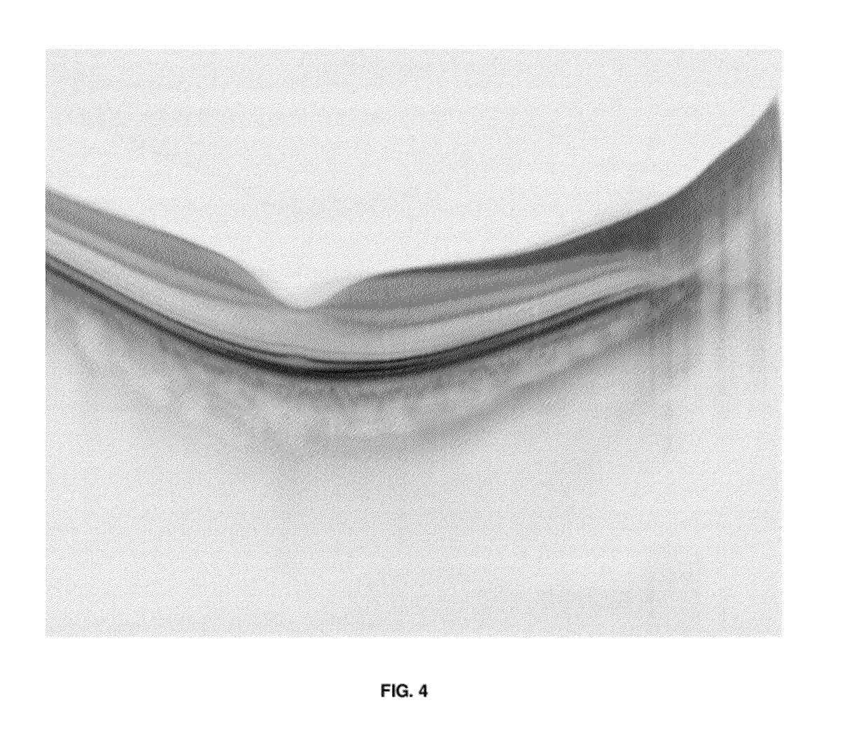

FIG. 4 is a cross-sectional OCT image generated through the averaging of multiple B-scans targeting at the same location. This image shows an image blurring artifact caused by averaging multiple B-scans due to motion during acquisition. This blurring artifact negates the potential quality improvement benefits of averaging multiple B-scans acquired exactly at the same location. The embodiments disclosed herein are developed to remove these motion artifacts and improve the overall OCT image quality.

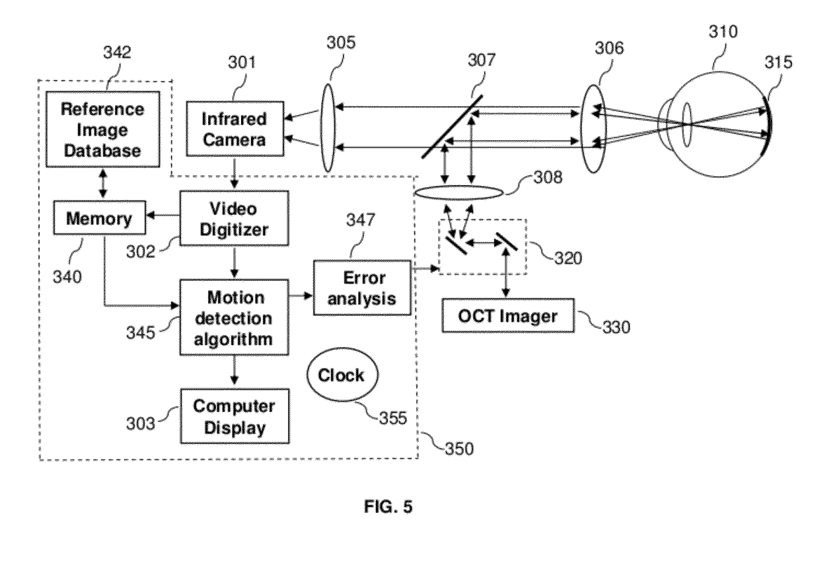

FIG. 5 is an exemplary embodiment of an OCT system according to aspects of the present invention. In the system illustrated in FIG. 5, additional processing elements detect and evaluate transverse motions in the sample. The embodiment of OCT system illustrated in FIG. 5 includes an OCT imager 330, two-dimensional (2D) transverse scanners 320, a beam splitter 307 to provide simultaneous viewing of the sample 310 and the imaged region of interest 315. OCT imager 330 includes an OCT light source to provide light out of OCT imager 330 and a detector system for receiving and analyzing light reflected into OCT imager 330 in order to provide an OCT image. OCT imager 330 can, for example, be a Fourier-domain OCT system, but a time-domain OCT system can also be used. In addition, the Fourier-domain OCT system can either be based on a spectrometer or a rapidly tuned laser, or a “swept source”. OCT imager 330 can be similar OCT to imager 130 shown in FIG. 1.

Simultaneous viewing of the scanning region, the region of interest 315, is provided by an infrared camera 301 where the video images are captured by a video digitizer 302 for display onto a computer display 303 to provide the operator continual feedback of the OCT scanning position relative to the anatomical region of interest during image acquisition. Optical lenses 305, 306 and 308 focus the OCT beam and the video image on the region of interest 315 in the sample 310.

In some embodiments, the video based tracking elements, as depicted in FIG. 5, comprises a computer 350 which includes a video memory storage 340, a processor for motion detection algorithm 345, and a module for error analysis 347. Video memory storage 340 stores video frames of the region of interest 315 which are then evaluated real-time by the motion detection algorithm 345 to detect whether any transverse motion has occurred. The motion detection algorithm 345 identifies transverse motion present in the video frames and performs error analysis 347 to compute positional offset (error offset) and determine if OCT scan position is required to be adjusted to stay on target with the intended OCT scan position. This error offset can then be applied to the two-dimensional (2D) transverse scanners 320 to provide real-time motion correction in response to the motion detected in the video frames. Computer 350 can be any device capable of processing data and may include any number of processors or microcontrollers with associated data storage such as memory or fixed storage media and supporting circuitry. In some embodiments, computer 350 can include a computer that collects and processes data from OCT 330 and a separate computer for further image processing. The separate computer may be physically separated.

In some embodiments, the fixation position of the OCT system can be adjusted to increase the area of the region of interest 315. For instance, an offset can be introduced to the fixation position so that the subject's fixation gaze is not centered on the center of the video frame. For example, this fixation offset can be adjusted to bring more of the optic disc region into the video frame. The optic disc in the video image can further serve as a high contrast reliable feature in the fundus for detecting motion and computing the transverse offset.

In some embodiments, the video memory storage 340 can obtain a reference video frame from a reference image database 342. In some embodiments, this reference video frame was acquired in an imaging session from a subject's previous office visit to act as a reference for follow-up visits. The real-time video images captured by the video digitizer 302 can be compared to this reference video frame to determine the offset between the current OCT scan position and the desired OCT scan position. This position offset can then be applied to the two-dimensional (2D) transverse scanners 320 to adjust for scan position and to enable acquisition of reproducible OCT scan locations over office visits.

In accordance with some embodiments, the optic disc in the video frame can be isolated and detected automatically when performing the motion detection algorithm. Tracking the position of the optic disc over multiple office visits has an advantage over tracking other retinal features of the eye because the position and contrast of the optic disc are relatively more prominent and stable over time. Other retinal features in the video frame are often changed due to disease progression or therapeutic treatment.

In some embodiments, the acquisition timing properties for the infrared video and the OCT imaging are determined using a clock 355 in the computer. The onboard high-precision computer clock 355 can be used to determine the precise timing relationship between an infrared video frame and an OCT image frame. This further reduces the cost and complexity of the system by eliminating the need for an additional hardware triggering capability on the infrared video camera.

In some embodiments of the present invention, properties of the infrared video camera and the OCT scanners, such as position and aspect ratio, are utilized for calibration using a feature of a known size and dimensions. This calibration process ensures a proper and controlled relationship between the video camera and the OCT scanner so that the transverse motion offset from the video frames and the error offset signals can be accurately applied to provide real-time motion correction.

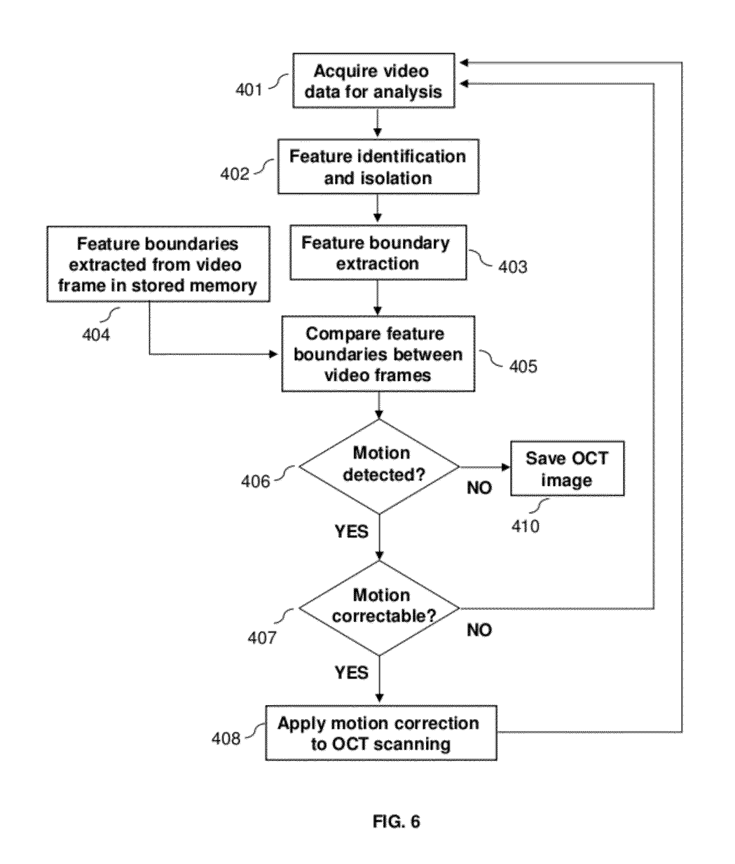

FIG. 6 is an exemplary flowchart of the motion detection and error analysis algorithm in accordance with some embodiments of the present invention. In FIG. 6, the real-time video data is acquired by the video digitizer 302 for analysis, as in step 401. An automatic feature identification and isolation, step 402, can be applied to the video frame in order to isolate a certain region of interest in the video image. For example, the optic disc in the fundus can be detected and isolated automatically for further motion analysis. Either a subset or the entire video frame can undergo feature boundary extraction in step 403. Feature extraction algorithms commonly known in the field can be used in this step. For example, an edge detection algorithm that detects discontinuities in the image intensity can be used. Similarly, a video frame that was previously acquired and stored in memory 340 also undergoes similar image processing to generate its corresponding feature boundary extraction as in step 404 that is then used to compare with the extracted feature from the live video frame in step 403. The video frame in the memory 340 can be a prior frame acquired from the live video stream for image tracking within the same visit or a reference video frame acquired in a previous office visit for tracking OCT scan location across multiple office visits. In step 405, the feature boundaries extracted from the live video frame 403 and the video frame in the memory 404 are compared to determine the transverse motion between these video frames. If motion is not detected by the feature boundary comparison in step 406, then there is no detectable motion between the two video frames and the OCT images acquired between these video frames can be saved for further processing in step 410. If motion is detected by the feature boundary comparison in step 406, the amount of detected motion is then compared with a preset limit of the motion correction range to determine if the detected motion is correctable. If the motion is correctable in step 407, a scanning position offset is calculated and sent to the OCT scanning apparatus 320, as in step 408, to correct for the positional offset caused by the motion. If the motion is outside the preset limit in step 407, and therefore not correctable, the process returns to the live video acquisition step 401 until the positional offset in the sample falls within the preset limit.

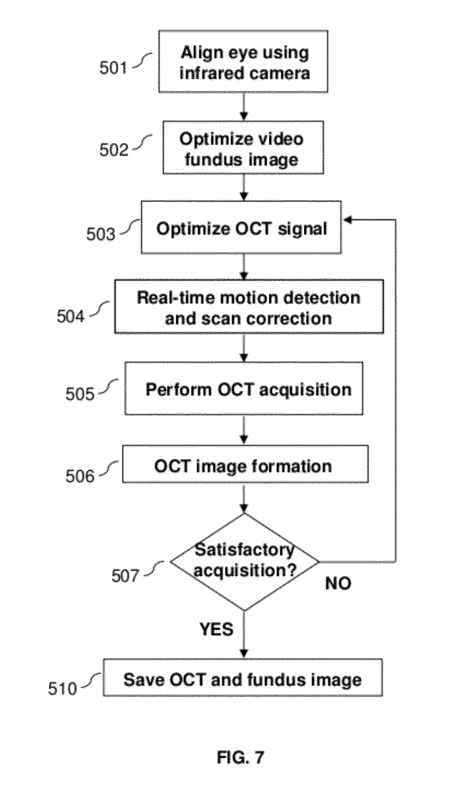

FIG. 7 is an exemplary flowchart for the OCT acquisition procedure using the real-time video motion detection and scan correction method as described in FIG. 6. In some embodiments, the operator uses the infrared camera 301 to align the sample 310 such as a human eye, as in step 501. As is commonly performed during OCT acquisition, once the sample 310 is sufficiently aligned in step 501, the operator then moves the OCT device closer to the sample 310 in order to focus and optimize the video image on the region of interest 315 such as the fundus of a human eye as in step 502. After the video image showing the region of interest 315 is sufficiently optimized, the operator proceeds to optimize the OCT signal in step 503 in preparation for OCT data acquisition in step 505. Before the start of OCT data acquisition in step 505, real-time video motion detection and scan correction, step 504, is applied in order to provide real-time tracking of OCT scan position as described in FIG. 6. Next, in step 505 OCT image acquisition is performed under real-time tracking of the OCT scan position, and the OCT images can then be generated using standard signal processing techniques as in step 506. The operator can decide in step 507 whether the acquired OCT images are of sufficient quality and save the OCT data and fundus video image as in step 510 or re-start the OCT image acquisition process and return to step 503.

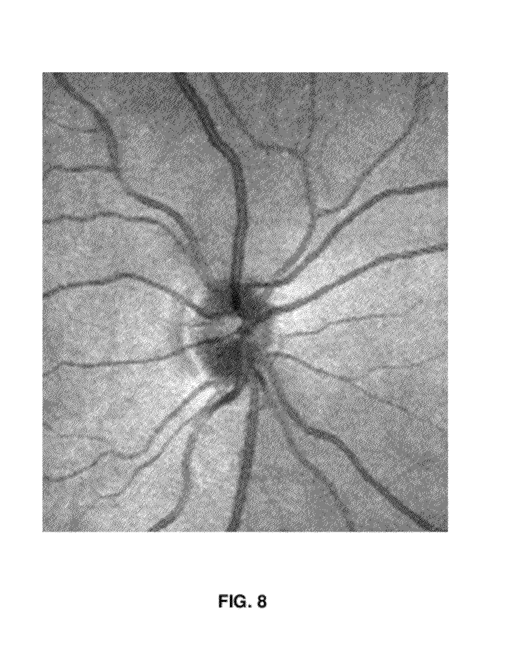

Applying some embodiments of the present invention can reduce or remove the motion artifact shown in FIG. 3. FIG. 8 is a three-dimensional OCT data set that was acquired over a region of the human optic nerve head with little or no motion artifact using the system in FIG. 5. With the addition of real-time tracking of OCT scan position, the entire three-dimensional OCT data set can be acquired with little or no motion artifact, as opposed to the artifacts 300 as shown in FIG. 3. No obvious blood vessel disruption or discontinuity of anatomical feature is observed in the motion corrected 2D representation of the 3D OCT data set in FIG. 8. Involuntary motion such as micro-saccades, heart beats, respiration, and head motion can be significantly reduced or successfully removed with real-time motion tracking.

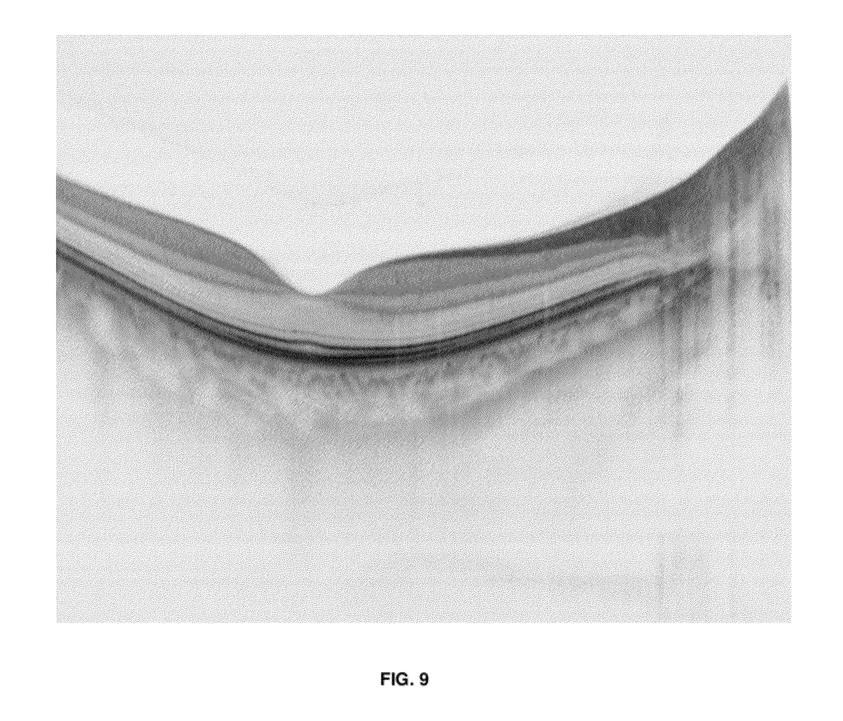

With the addition of real-time OCT tracking to a standard OCT system, the benefits of averaging multiple B-scans to improve image quality can be significantly enhanced. FIG. 9 shows a cross-sectional OCT image generated by averaging multiple B-scans acquired using some embodiments of real-time OCT tracking described herein. In general, image quality of an OCT image can be improved through averaging multiple B-scans acquired at the same intended location. However, when the number of B-scans used for averaging increases, the OCT image obtained through averaging likely contains blurring artifacts as a result of the superimposition of signals obtained not at the exact same intended locations due to motion. The real-time OCT tracking disclosed herein can improve the OCT image quality by increasing the number of B-scans used for averaging without introducing any blurring artifact. A detailed and feature rich averaged B-scan using the real-time OCT tracking is shown in FIG. 9.

In accordance with some embodiments, the image quality of multiple B-scan averaging can further be enhanced by performing OCT image alignment in the transverse, axial, and rotational directions before applying B-scan averaging. Each acquired OCT image can be correlated to a reference OCT image in the axial and/or transverse direction to achieve best OCT image alignment. In some embodiment, to achieve rotational alignment, each A-scan in an OCT image can be correlated along the axial direction with a corresponding A-scan in the reference OCT image. This image alignment method based on the OCT image can remove axial motion from the subject that cannot be corrected by real-time video tracking. The combination of real-time transverse motion correction and axial motion image alignment enables the acquisition of OCT data from a well-defined scan location in the three-dimensional space.

In accordance with some embodiments of the present invention, simple and rapid real-time OCT tracking can be achieved in the apparatus discussed in FIG. 5. SLO based tracking systems typically acquire SLO images at 15 frames per second while standard video systems acquires images at 30 frames per second, or even up to several hundred frames per second with advanced video cameras. Video based tracking systems as disclosed herein are easier to operate than SLO-based tracking methods because SLO imaging can only be performed when the retina is located within several millimeters of the optimal SLO sectioning position. Moreover, some embodiments of the present invention as disclosed in FIG. 5 do not expose the subject to an additional optical radiation, as in the case using SLO imaging.

Video based tracking is easily adaptable as most commercially available OCT imaging devices use near-infrared videos of the object for operator aiming. Therefore, the systems and methods disclosed herein can enable video based tracking on these OCT imaging devices with little modification, such as a software and/or a firmware upgrade.

The systems and methods disclosed herein can also improve evaluation of disease progression because OCT data can be tracked more accurately over multiple office visits. In order to track disease progression or response to treatment, it is desirable to perform OCT measurements, such as properties and characteristics of retinal and/or intra-retinal thicknesses, at the same location over multiple office visits. Video-based real-time tracking can remove eye motion during acquisition and account for the changes in patient's fixation from one visit to another. This enables the acquisition of OCT scans at identical locations over office visits and improves the quality of the OCT measurements, such as the retina or intra-retinal layers.

While various aspects and embodiments have been disclosed herein, other aspects and embodiments will be apparent to those of ordinary skill in the art. The various aspects and embodiments disclosed herein are for purposes of illustration and are not intended to be limiting, with the true scope and spirit being indicated by the following claims. Those ordinarily skilled in the art will recognize, or be able to ascertain using no more than routine experimentation, many equivalents to the specific embodiments of the method and compositions described herein. Such equivalents are intended to be encompassed by the claims.

We claim:

1. An optical coherence tomography (OCT) system, comprising:
an OCT imager;
a two-dimensional transverse scanner coupled to the OCT imager, the two-dimensional transverse scanner receiving light from the light source and coupling reflected light from a sample into the OCT imager;
optics that couple light between the two-dimensional transverse scanner and the sample;
a video camera coupled to the optics and acquiring images of the sample; and
a computer coupled to receive images of the sample from the video camera, the computer processing the images and providing a motion offset signal based on the images to the two-dimensional transverse scanner.

2. The system of claim 1, wherein the computer executes a motion detection algorithm to calculate an amount of motion and executes an error analysis to determine the motion offset signal.

3. The apparatus of claim 2, wherein the motion detection algorithm compares the image with a stored image in a memory module to detect motion.

4. The apparatus of claim 3, wherein the stored image is provided in an image database.

5. The apparatus of claim 1, wherein a computer clock can be used to synchronize the OCT imaging apparatus and the video camera.

6. The apparatus of claim 1, wherein the OCT imager can be based on spectrometer or tunable laser.

7. An imaging method, comprising:
directing an OCT light source from an OCT imager onto a sample;
capturing an OCT image in the OCT imager;
capturing video image of the sample using a video camera;
analyzing the video image to determine a motion correction; and
adjusting positioning of the OCT light source on the sample in response to the motion offset.

8. The system of claim 7, wherein analyzing the video image to determine a motion correction includes
calculating an amount of motion from the video image, and
determining the motion offset signal from the amount of motion.

9. The apparatus of claim 8, wherein calculating the amount of motion includes comparing the image with a stored image in a memory module to detect motion.

10. The apparatus of claim 9, wherein the stored image is provided in an image database.

11. The apparatus of claim 7, wherein capturing the OCT image and capturing the OCT image is synchronized with a computer clock.

12. The apparatus of claim 7, wherein capturing the OCT image includes utilizing a spectrometer or tunable laser.
